(19) United States
(12) Patent Application Publication
(10) Pub. No.: US 2005/0018960 A1
(43) Pub. Date: Jan. 27, 2005

(54) Dynamic spectral equalizer using a programmable holographic mirror

(76) Inventors: Jean-Louis De Bougrenet De La Tocnaye, Guilers (FR); Raymond Chevalier, Plougonvelin (FR); Jean-Luc Kaiser, Brest (FR)

Correspondence Address: MERCHANT & GOULD PC, P.O. BOX 2903, MINNEAPOLIS, MN, 55402-0903, US

(21) Appl. No.: 10/490,898

(22) PCT Filed: Nov. 14, 2002
(86) PCT No.: PCT/FR02/03906

(30) Foreign Application Priority Data
Nov. 14, 2001 (FR) 01/14756

(51) Int. Cl. G02B 6/26

(52) U.S. Cl. 385/27

(57) ABSTRACT

The invention relates to a dynamic spectral equaliser comprising: means of demultiplexing an incident beam with at least two multiplexed wavelengths, comprising at least one first dispersive optical element, so as to form a spatial multiplex of the said at least two wavelengths; means of attenuating the spectral power associated with at least one wavelength of the said spatial multiplex, comprising at least one programmable semi-transparent holographic mirror, so as to form an equalised spatial multiplex; means of multiplexing the said equalised spatial multiplex, comprising at least one second dispersive optical element, so as to form an equalised beam with at least two multiplexed wavelengths.

The domain of this invention is telecommunications by optical fibres. More precisely, the invention relates to a dynamic spectral equaliser, capable of equalising the spectral power density of the transmitted signal, within the context of a multi-channel transmission system.

The Dense Wavelength Division Multiplexing (DWDM) technique is more and more frequently used for optical telecommunications. It provides a means of increasing the data transfer rate through a single-mode fibre, while simultaneously propagating light from several spectrally distinct laser sources with equal powers, through the optical fibre.

Each laser source is associated with a propagation channel in the fibre. In a conventional transmission system, there are usually about forty channels separated by about 50 GHz (namely about 0.4 nm). The band width of each laser source is very generally less than the space between channels.

In order to optimise operation of DWDM type telecommunications networks, it is necessary to make sure that powers transported by each channel in the system are approximately equal to each other when light is propagated through the grating from one transmitter to a receiver.

In other words, it is preferable if the transmission system does not have any spectral ripples, in other words if it has a flat power spectral density over the entire transmission band width considered. When the powers associated with each channel are different, the spectral power density is no longer flat since the power per channel formed by a narrow band around a central wavelength is not constant.

In an optical communication system, there are many effects that could generate losses and gains within the transported signal, dependent on the wavelength of the transmitted signal. Some of these effects may be generated intentionally, for example such as the addition or deletion of channels, by using an Optical Add/Drop multiplexer (OADM). Other effects such as absorption, diffusion and other non-linear effects that occur in doped or undoped fibres, depend on the propagation distance and dispersive properties of fibres.

As in most optical communication systems, in DWDM systems it is also necessary to place amplifiers to amplify the optical signal at regular intervals along the optical path, to compensate for power losses induced by the above effects.

At the moment, there are several types of optical amplifiers. Some of the most widespread amplifiers include Semiconductor Optical Amplifiers (SOA), non-linear amplifiers such as Raman type amplifiers, and Erbium Doped Fibre Amplifiers (EDFAs).

SOA and Raman type amplifiers can operate on sufficient band widths to cover the majority of the S, C and L bands (remember that the S band corresponds to wavelengths between approximately 1480 nm and 1520 nm, the C band corresponds to wavelengths between approximately 1525 nm and 1565 nm, and the L band corresponds to wavelengths between approximately 1570 nm and 1620 nm). However, Raman amplifiers have the disadvantage of generating large gain variations over a wide spectral band (of the order of a few hundred nanometers) dependent on the channel load. The spectral power density of the transported signal has to be flattened in order to reduce these gain variations.

One solution proposed to solve this problem consists of increasing the density and the number of Raman pumps used in such a system. But this solution has the disadvantage that it is very expensive.

Therefore in order to reach a necessary compromise between costs and performances, and to solve the problem of gain variations mentioned above, it is necessary to design efficient Dynamic Spectral Equalisers (DSEs) that are adapted to the amplification techniques described above and that operate on wide spectral bands.

This necessity is further increased for DWDM type systems compared with classical optical communication systems, since DWDM systems require a large number of optical amplifiers and usually have long optical fibre lengths, which aggravates the effects having an influence on the spectral power density, and described above.

At the moment, two main dynamic spectral equalisation techniques are known, namely equalisation by individual channel and equalisation by Fourier filtering:
equalisation by individual channels consists of separating or demultiplexing the channels, adjusting the power of the channels separately, and then recombining or remultiplexing the channels;
dynamic spectral equalisation by Fourier filtering consists of decomposing the gain curve of the optical system considered into five to ten 3 to 6 nm wide windows. The individual windows are then adjusted independently of the number of channels that they comprise. The technologies used for Fourier filtering are limited, and in particular include Mach-Zehnder thermo-optic devices, Acousto-Optic Tunable Filters (AOTF), and Electronically Switchable Bragg Gratings (ESBG).

There are many disadvantages with these different known dynamic spectral equalisation techniques by individual channels or by Fourier filtering.

Thus, with Mach-Zehnder type thermo-optic devices, there is the disadvantage that they generate large dissipation of heat in the wave guides substrate, and a low reconfiguration rate.

Remember that a thermo-optic Mach-Zehnder filter is a Mach-Zehnder interferometer with a temperature controlled wave guide. The optical path of the interferometer arms is controlled by modifying the temperature of the refractive material from which the arms are made. The beams are then combined using a coupler with two outputs. Each output only supports one of the wavelengths under specific constructive interference conditions, and different wavelengths can be adjusted by differences in the optical path by changing the temperature of the refractive material.

AOTF type filters use the Bragg effect that occurs when acoustic waves are created in a refractive material co-linearly along the propagation direction of light. Acoustic waves are created by putting the material into a radio-frequency (RF) field. In turn, they create compression and expansion areas that generate a modulation of the refraction index, thus forming a periodic Bragg structure.

One disadvantage of this technique according to prior art is that this type of AOTF filters requires high power radio-frequency signals. Such filters are also expensive and have a high noise factor.

ESBG type gratings also use the Bragg effect. They can be made from holographic technologies based on polymer dispersed liquid crystal (also called a holo-PDLC). This technology is used to make volume phase holograms in a polymer substrate by a process that enables control of the diffractive pass band and the central wavelength of the system. The diffractive structure can be deleted by application of an electric field. Thus, coupling between the guide and the substrate can be controlled while minimising insertion losses and Polarisation Dependent Loss (PDL). This technology is very fast, with reconfiguration times of the order of 100 μs, which provides a means of cascading a large number of gratings without a negative impact on the system response time.

One equalisation technique using ESBG type grating typically consists of cascading a plurality of wave guides. All wavelengths in an incident beam pass through all Bragg gratings thus cascaded and are affected by a corresponding power attenuation.

Therefore, the pass bands of ESBG-based equalisers are usually very limited. In order to increase the pass band, many wave guides have to be cascaded and this is expensive and introduces many problems due to the complexity of the transmission function of the assembly thus formed.

Moreover, known ESBG-based equalisation systems are usually dependent on polarisation of incident light due to the lack of circular symmetry of wave guides and back scattering. Their spectral range is often insufficient, and the slope of attenuation as a function of the wavelength is generally high.

Free space approaches according to prior art based on equalisation by individual channels, are well adapted to the treatment of wide spectral ranges (100 nm or more). However, these approaches according to prior art also have many disadvantages.

A first disadvantage of such solutions is that they are dependent on polarisation and temperature. Furthermore, these approaches by isolated channels are incapable of equally well processing large spectral ranges and isolated wavelengths, although this is necessary for long distance and metropolitan gratings.

Another disadvantage of these solutions is that they are usually not conform with submarine specifications due to the large volume occupied by devices designed using these technologies.

Free space approaches also have the disadvantage that they have slow response times, which can be a severe limitation for management of OADMs in metropolitan gratings.

One of the main purposes of the invention is to overcome these disadvantages according to prior art.

More precisely, one purpose of the invention is to provide a dynamic spectral equalisation technique for equalising optical signals with several distinct wavelengths.

Another purpose of the invention is to implement such an equalisation technique that is fast and suitable for wide spectral bands.

Another purpose of the invention is to use such a spectral band equalisation technique that is independent of polarisation of the incident beam.

Another purpose of the invention is to implement such a spectral equalisation technique that is independent of the temperature.

Another purpose of the invention is to provide such a technique that has low reconfiguration times.

Another purpose of the invention is to provide such an equalisation technique that is adapted to any type of optical communication grating, particularly long distance gratings, metropolitan gratings and submarine gratings.

These objectives, and others that will become evident later, are achieved by means of a dynamic spectral equaliser comprising:
means of demultiplexing an incident beam with at least two multiplexed wavelengths, comprising at least one first dispersive optical element, so as to form a spatial multiplex of the said at least two wavelengths;
means of attenuating the spectral power associated with at least one wavelength of the said spatial multiplex, comprising at least one programmable semi-transparent holographic mirror, so as to form an equalised spatial multiplex;
means of multiplexing the said equalised spatial multiplex, comprising at least one second dispersive optical element, so as to form an equalised beam with at least two multiplexed wavelengths.

Thus, the invention is based on a very new and inventive approach of dynamic spectral equalisation, based on the combination of optics in free space with a high dispersive capacity and a programmable semi-transparent holographic mirror. Therefore this type of spectral equalisation technique offers an innovative solution that consists of implementing firstly a multiplexing/demultiplexing technique, and secondly a programmable semi-transparent holographic mirror to attenuate an isolated wavelength or a band of wavelengths from a multiplex of wavelengths transported in the form of an optical signal. Advantageously, this type of approach makes it possible to adapt the equalisation device to changes of one or several wavelengths in the multiplex. It also enables faster response times than techniques according to prior art.

Preferably, the said first and second dispersive optical elements are coincident.

The dynamic spectral equaliser thus designed is more compact.

Preferably, the said holographic mirror is optically recorded in polymer dispersed liquid crystal (PDLC) so as to form a holo-PDLC.

Remember that holo-PDLCs contain liquid crystal droplets presenting an electro-optical effect, and that their periodic structure can be modified (or can change from an active state to an inactive state) by applying an electric field.

According to one advantageous characteristic of the invention, the said holographic mirror is a thick holographic grating in reflection.

Preferably, the said holographic grating in reflection is chirped.

In other words, a spatial chirp is introduced (in other words a spatial variation of the period of the grating approximately in the form of a ramp) into the holographic grating. This characteristic makes it possible to make the dynamic spectral equaliser according to the invention achromatic, which is a major improvement compared with dynamic spectral equalisation techniques according to prior art.

Advantageously, the said holographic mirror comprises at least two strata, the direction of propagation of the said incident spatial multiplex on the said holographic mirror is approximately perpendicular to the said strata.

In this way, attenuation of the wavelengths induced by the holographic mirror is insensitive to the polarisation of the spatial multiplex.

The said dispersive optical element is preferably a thick phase holographic grating.

This type of dispersive optical element may be of any other nature capable of performing a multiplexing and demultiplexing function on the beam of wavelengths.

According to one advantageous characteristic of the invention, this type of dynamic spectral equaliser also comprises:
at least one input port of the said incident beam with at least two multiplexed wavelengths into the said equaliser;
at least one first output port of the said equalised beam with at least two multiplexed wavelengths from the said equaliser;

In this way, the incident beam of multiplexed wavelengths enters into the equaliser according to the invention through the input port, and after equalisation, exits from the equaliser through the first output port.

According to one advantageous embodiment of the invention, the said input port and the said first output port are coincident.

Preferably, the said at least one holographic mirror comprises at least two electrodes for electrically controlling the reflectivity of at least some areas of the said mirror.

Thus, the fraction of the energy in the incident wavelength that is reflected by the mirror can be controlled as a function of the voltage applied to the electrode terminals, so as to create equalisation adapted as a function of each of the wavelengths of the incident beam. In particular, the surface of the holographic mirror can be decomposed into several pixels, each of which will receive a different wavelength of the incident multiplex, and for which the reflectivity can be individually controlled by an appropriate set of electrodes.

In one preferred embodiment of the invention, such an equaliser also comprises:
an input optical fibre (Fᵢₙ) transporting the said incident beam with at least two multiplexed wavelengths to the said input port;
a first lens (L1) positioned such that the said input port is in the object focal plane of the said first lens;
a second lens (L2) positioned such that the said holographic mirror is in the object focal plane of the said second lens, and that the object focal plane of the said second lens is coincident with the image focal plane of the said first lens;
an output optical fibre (Fₒᵤₜ) that receives the said equalised beam with at least two multiplexed wavelengths, from the said first output port.

Thus, a 4-f system is made, namely a double diffraction imagery system.

According to a first variant embodiment of the invention, the said dispersive optical element is located in the image focal plane of the said first lens (L1) and in the object focal plane of the said second lens (L2).

According to a second advantageous variant of the invention, the said dispersive optical element is a grism, comprising two prisms and a non-inclined volume phase holographic grating, and the said input optical fibre is located on the optical axis of the said equaliser.

Advantageously, this type of equaliser also comprises a three-port circulator, capable of transmitting the said incident beam with at least two multiplexed wavelengths of the said input optical fibre (Fᵢₙ) to the said input port and transmitting the said equalised beam with at least two multiplexed wavelengths of the said output port to the said output optical fibre (Fₒᵤₜ).

Thus, this type of circulator can block the passage of the equalised beam from the output port to the input optical fibre, and therefore isolates the input optical fibre from the output optical fibre.

According to one particular embodiment of the invention, the said dispersive optical element is used in a configuration in reflection, and the said first and second lenses are coincident.

This type of configuration gives a significant improvement in compactness of the spectral dynamic equaliser according to the invention. It should be noted that in this configuration, the concepts of the object focal plane and the image focal plane of the lens are related only to the direction of the light path: in other words, the object focal plane of the lens when light passes through the lens from the input port to the dispersive optical element, corresponds to the image focal plane of this same lens when light passes through the lens from the dispersive optical element to the holographic mirror; and the image focal plane of the lens when light passes through the lens from the input port to the dispersive optical element, corresponds to the object focal plane of this same lens when light passes through the lens from the dispersive optical element to the holographic mirror.

According to a second variant embodiment of the invention, the said dispersive optical element is located between the said first and second lenses, near the said first lens.

Changing the location of the dispersive optical element can be used to add an angular multiplex to the spatial multiplex, in the imagery plane.

In one advantageous embodiment of the invention, the said dispersive optical element and the said first lens are replaced by a single holographic lens, chosen such that the axial radius of a wavelength of the said beam with at least two multiplexed wavelengths passes through the focus of the said holographic lens.

Thus, in this configuration, the angular multiplex is located around the perpendicular to the holographic mirror, in other words at least one of the wavelengths of the multiplexed beam arrives on the holographic mirror perpendicularly to the holographic mirror. It can be seen that since the system is of the 4-f type, the focus of the holographic lens coincides with the focus of the second lens (L2).

According to one advantageous embodiment of the invention, this type of equaliser also comprises a second output port, capable of receiving at least one wavelength of the said spatial multiplex transmitted by the said holographic mirror.

Thus, apart from the equalised wavelengths reflected by the holographic mirror that are retrieved on the first output port, it would also be possible to retrieve the wavelengths transmitted by the holographic mirror on a second output port, using an optical system symmetric with the system used in the equaliser described in this application.

According to a first variant embodiment of the invention, the said dispersive optical element is a non-inclined volume phase holographic grating and the said input optical fibre is located at a distance from the optical axis of the said equaliser.

This type of non-inclined holographic grating has several technological advantages compared with gratings with inclined strata, particularly insensitivity to thickness changes.

In another particular embodiment of the invention, the said spatial multiplex is projected onto the said holographic mirror by a first mirror (M1), and the said equalised spatial multiplex transmitted by the said holographic mirror is aimed towards the said second lens by a second mirror (M2).

Preferably, at least one of the first and second mirrors is a prism with total internal reflection.

Advantageously, the said input and output optical fibres are symmetrically located about the said optical axis.

According to a first advantageous characteristic of this embodiment, such an equaliser also comprises an isolator to isolate the said input optical fibre from the said equalised beam with at least two multiplexed wavelengths.

In this way, the unequalised beam reflected by the holographic mirror cannot be reinjected into the input fibre.

Preferably, the said holographic mirror is placed in a virtual focal plane that is an image of the image focal plane of the said second lens by the said first mirror (M1).

Preferably, the said first and second mirrors form an angle of approximately 45° from the said optical axis, and the said holographic mirror is placed along the said optical axis.

According to a second advantageous characteristic of this embodiment, the said holographic mirror is a holographic mirror with inclined strata, and is placed at a distance from a virtual focal plane, that is the image of the image focal plane of the said second lens by the said first mirror, such that the said spatial multiplex reflected by the said holographic mirror is not reinjected into the said input optical fibre.

Advantageously, the said equalizer also comprises a second output port, capable of receiving at least one wavelength of the said spatial multiplex reflected by the said holographic mirror.

Other characteristics and advantages of the invention will become clear after reading the following description of a preferred embodiment given simply as an illustrative and non-limitative example, and the attached drawings among which:

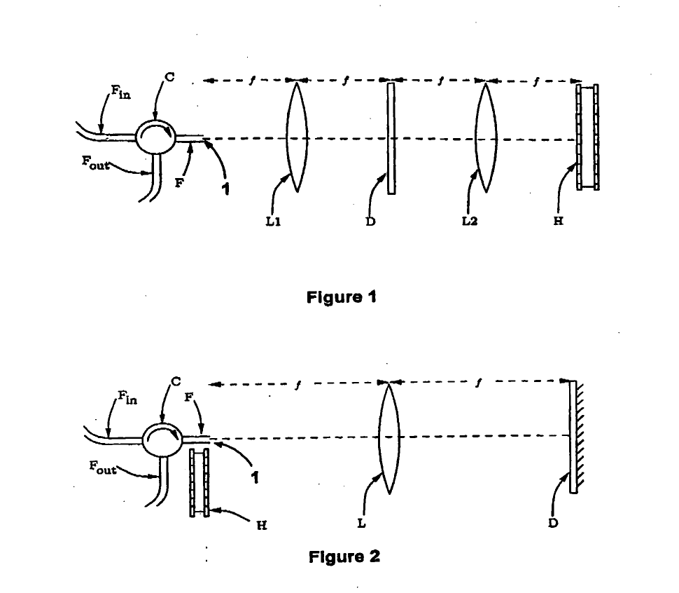

FIG. 1 shows a block diagram of a first embodiment of a dynamic spectral equaliser according to the invention;

FIG. 2 illustrates a folded version of the spectral equaliser in FIG. 1;

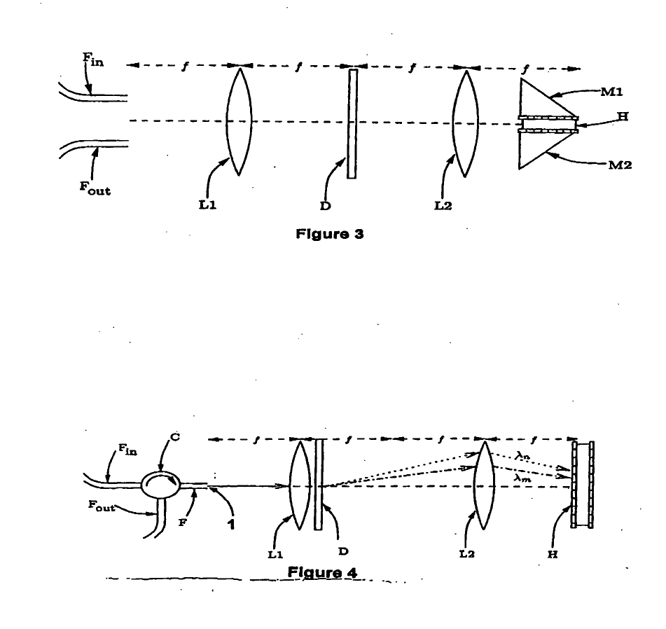

FIG. 3 describes a third embodiment of the invention, in which the thick switchable hologram is placed along the optical axis;

FIG. 4 shows a fourth embodiment of the invention, in which the location of the dispersive optical element has been changed from the embodiment shown in FIG. 1;

FIG. 5 illustrates a fifth embodiment of the invention, using a holographic lens;

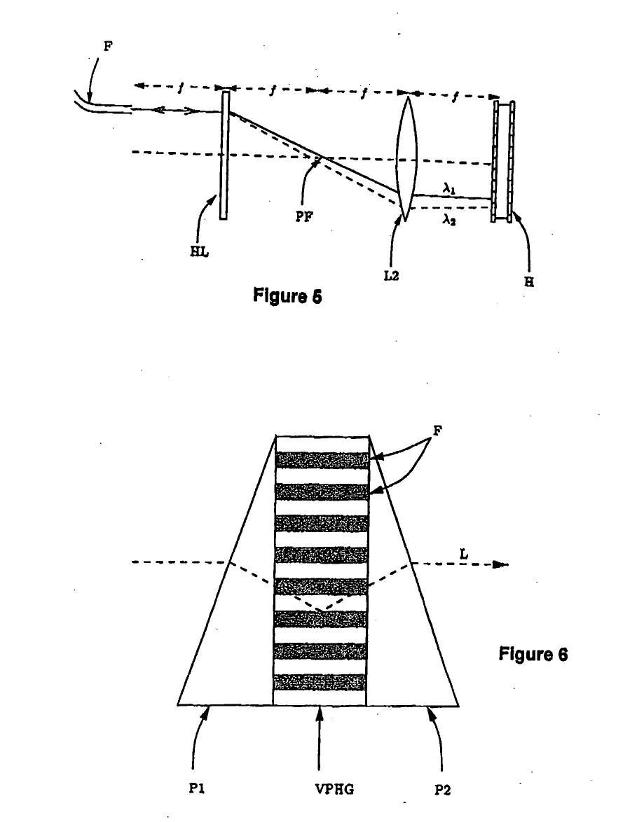

FIG. 6 shows an example of a dispersive optical element that could be used in a dynamic spectral equaliser according to the invention;

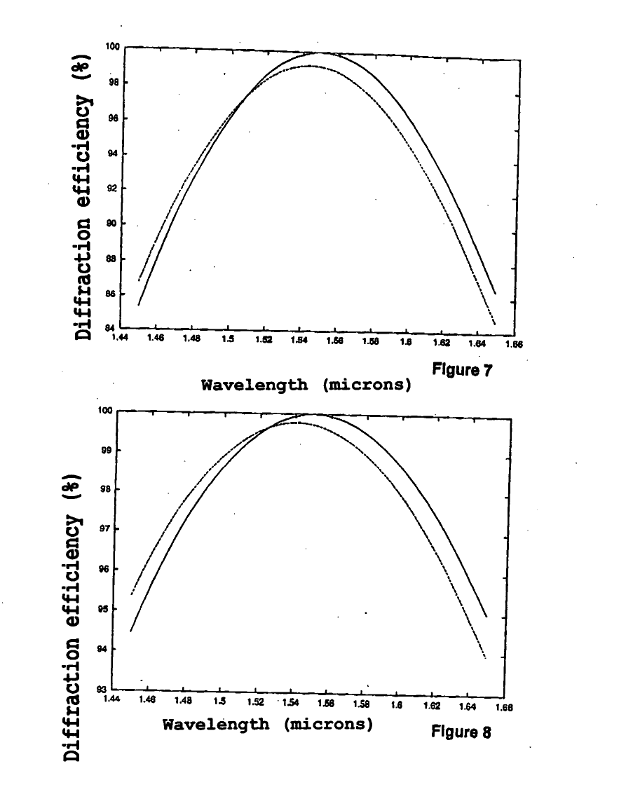

FIGS. 7 and 8 illustrate the diffraction efficiency of a dispersive optical element according to the invention, as a function of the wavelength;

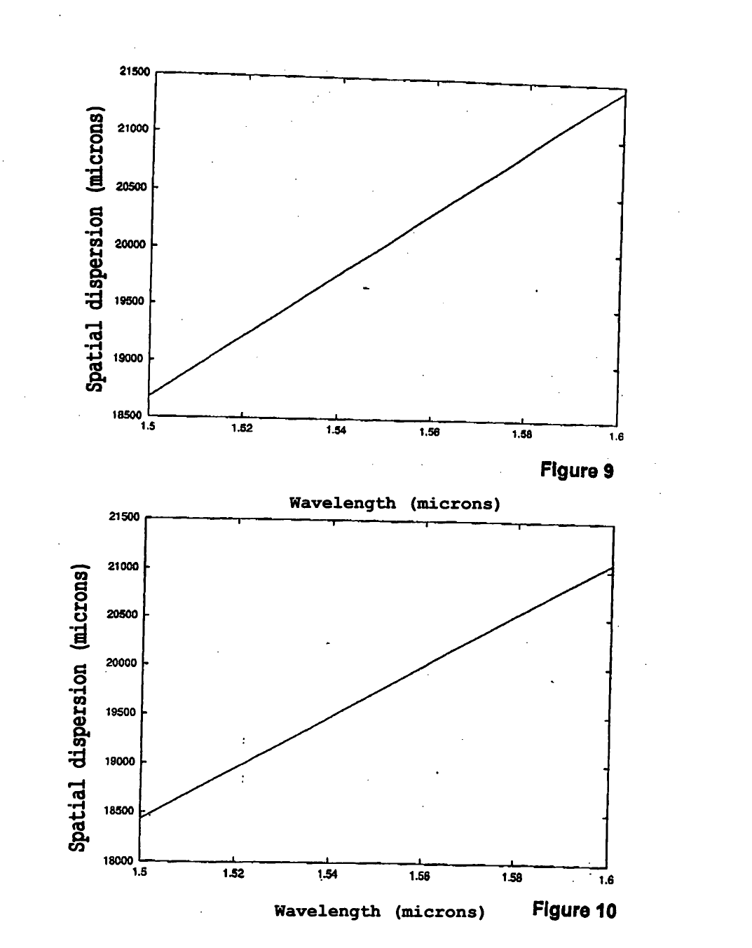

FIGS. 9 and 10 show the spatial dispersion spectrum of a dispersive optical element in FIG. 6, as a function of the wavelength;

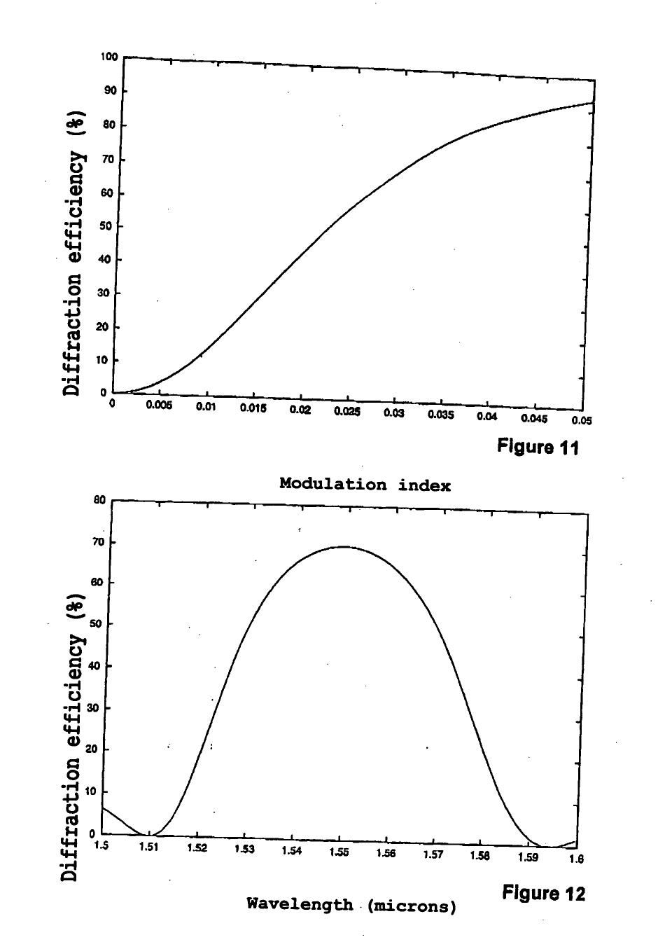

FIGS. 11 and 12 illustrate the diffraction efficiency of a phase hologram that can be used in a dynamic spectral equaliser according to the invention;

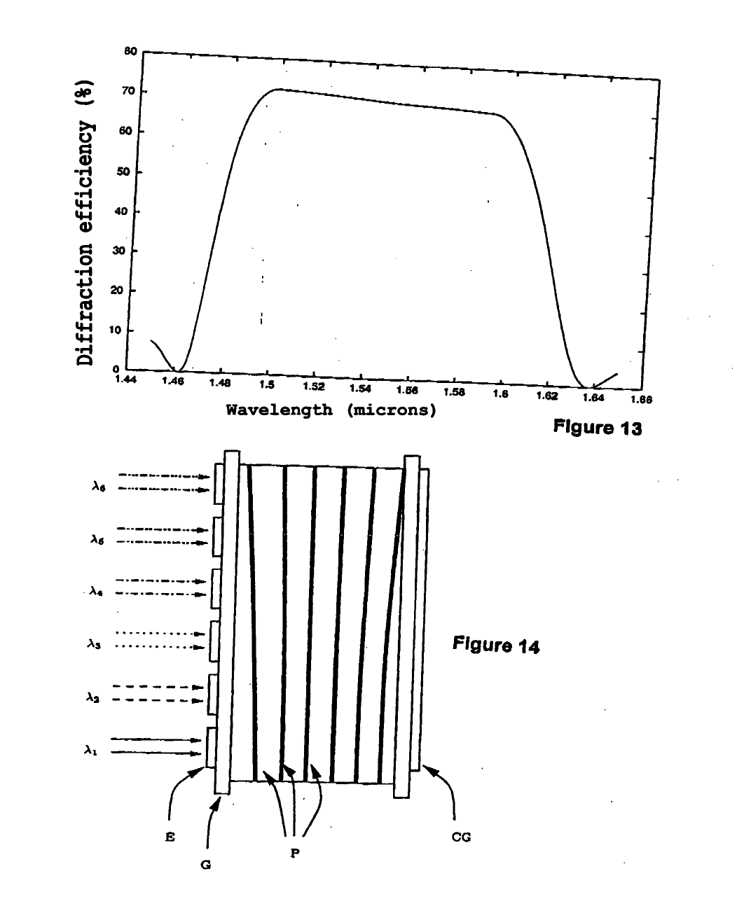

FIG. 13 shows the diffraction efficiency of a volume phase grating in reflection that can be used in a dynamic spectral equaliser according to the invention;

FIG. 14 shows a sectional view of a chirped hologram in reflection that is pixelised and can be used in a dynamic spectral equaliser according to the invention.

The general principle of the invention is based on the combination of optics in free space with a high dispersive capacity and a thick chirped grating in reflection, acting like a programmable semi-transparent mirror, used to attenuate isolated wavelengths or wavelength bands.

In one simple embodiment of the invention, a dynamic spectral equaliser receives a multiplex of wavelengths from an input port (typically an optical fibre) transporting data over a plurality of wavelengths λᵢ. At the output from the fibre, in a basic configuration, the Gaussian beam is imaged using a 4-f system, possibly with a magnification factor. For the remainder of this description, a 4-f system denotes a system comprising two lenses, in which the image focal plane of the first lens is coincident with the object focal plane of the second lens. This type of 4-f system performs imagery by double diffraction.

The multiplex of wavelengths is transformed into a spatial multiplex by means of a diffractive optical element (preferably a thick grating) located in the Fourier plane (in other words in the image focal plane of the first lens and in the object focal plane of the second lens of the above mentioned 4-f system). This spatial multiplex illuminates the thick switchable hologram. The diffraction structure recorded in the holographic medium is such that the hologram operates in a manner similar to a mirror and has a continuous spatial period modulation (or chirp) to compensate for the wavelength variation along the dispersion axis.

Electrodes are spatially distributed on the thick switchable hologram and are used to locally control the efficiency of the hologram, which behaves like a pixelised Spatial Light Modulator (SLM).

The different data flows carried by an isolated wavelength λᵢ or by a band of wavelengths, are focused on different pixels of the thick switchable hologram, and the fraction rᵢ of energy associated with the wavelength λᵢ reflected by the thick switchable holo-PDLC can be adjusted by means of a voltage applied to the pixel on which the wavelength λᵢ is focused.

The reflected wavelengths then pass through the dispersive optical element that behaves like a dispersion compensator, and the different wavelengths are all reinjected into the output port (typically an optical fibre).

The wavelengths transmitted by the thick switchable hologram (with an energy fraction equal to 1-rᵢ) can be reinjected into another port (for example another optical fibre), using an optical system symmetric to the system described above.

FIG. 1 presents a first example embodiment of a dynamic spectral equaliser according to the invention.

The equaliser in FIG. 1 receives a DWDM comb from an input optical fibre Fᵢₙ. This incident beam of multiplexed wavelengths is sent to the optical fibre F through a three-port circulator C. The output 1 of the optical fibre F is located in the object focal plane of a first lens L1. The DWDM comb is Fourier transformed by the first lens L1 on a dispersive optical element D located in the image focal plane of the lens. The effect of the dispersive optical element D is to transform the wavelength multiplex (or DWDM comb) into an angular multiplex.

This angular multiplex output from the dispersive optical element D is then transformed into a spatial multiplex by a second lens L2 that is positioned such that the dispersive optical element D is located in the lens image focal plane. The spatial multiplex output from the second lens L2 focuses in the object focal plane of the second lens, and illuminates the thick switchable hologram H.

For each wavelength λᵢ of the spatial multiplex illuminating the hologram H, an electrically controllable energy fraction rᵢ is reflected in the equaliser according to the invention, while the energy fraction tᵢ=1−rᵢ with wavelength λᵢ is transmitted through the thick switchable hologram H.

Wavelengths reflected in the equaliser in the form of an equalised spatial multiplex are projected onto the dispersive optical element D through the second lens L2, which retransforms the spatial multiplex equalised by the hologram H into an equalised angular multiplex. The equalised angular multiplex is in turn retransformed into a multiplex of wavelengths equalised by the dispersive optical element D.

Finally, the equalised multiplex of wavelengths output from the dispersive optical element D is focused on the optical fibre F by the first lens L1, and each wavelength of the multiplex is reinjected into the optical fibre F with a coupling efficiency proportional to the fraction of energy rᵢ reflected by the thick switchable hologram H. The input and output wavelengths in the equaliser in FIG. 1 are separated by the three-port circulator C, the output (and therefore equalised) wavelengths being sent to the output optical fibre Fₒᵤₜ and isolated from the input optical fibre Fᵢₙ.

We will now describe a second embodiment of the invention with relation to FIG. 2, in which the dispersive optical element D in FIG. 1 is used in a configuration in reflection. This type of embodiment has the advantage that it enables a significant improvement in compactness, the dynamic spectral equaliser thus designed being much more compact than that shown in FIG. 1.

A beam of several multiplexed wavelengths is incident on the dynamic spectral equaliser in FIG. 2 through the input optical fibre Fᵢₙ, and is transmitted to an optical fibre F through a three-port circulator C.

The input port of the incident beam of several multiplexed wavelengths into the equaliser corresponds to the output 1 from the optical fibre F and is located in the object focal plane of a lens L. The incident multiplex is Fourier transformed by the lens L on a reflecting dispersive optical element D located in the image focal plane of the lens L.

The reflecting dispersive optical element D transforms the multiplex of wavelengths into an angular multiplex, and reflects all wavelengths towards the lens L.

This lens transforms the incident angular multiplex into a spatial multiplex that illuminates a controllable semi-transparent holographic mirror H, located in the object focal plane of the lens L, in other words in the same plane as the equaliser input port.

For each wavelength λᵢ of the spatial multiplex, the holographic mirror H reflects a fraction rᵢ of the associated energy as a function of the voltage applied to the holographic mirror H, and the point of impact of the wavelength λᵢ on the holographic mirror H. These aspects will be described in more detail in the remainder of the document.

The beam at least partially reflected by the holographic mirror H in the form of an equalised spatial multiplex is retransformed into an angular multiplex by the lens L, that it passes through before illuminating the reflecting dispersive optical element D.

This dispersive optical element transforms the equalised angular multiplex into an equalised beam of multiplexed wavelengths, that it reflects towards the lens L.

The lens L then focuses the multiplex equalised in wavelengths onto the output 1 of the optical fibre F. The circulator C transmits the equalised beam of multiplexed wavelengths towards the output optical fibre Fₒᵤₜ and blocks its passage to the input optical fibre Fᵢₙ.

FIG. 3 shows a third embodiment of the invention, in which the thick switchable hologram (or the controllable semi-transparent holographic mirror) H is placed along the optical axis of the dynamic spectral equaliser. This configuration is such that the wavelengths equalised by the hologram H are injected into an output optical fibre Fₒᵤₜ remote from the input optical fibre Fᵢₙ without these two fibres actually being connected by a circulator.

The equaliser in FIG. 3 has a first lens L1, a dispersive optical element D, and a second lens L2 that performs functions similar to the functions performed by the equaliser in FIG. 1, and which will therefore not be described in further detail in this description.

The wavelengths of the spatial multiplex output from the second lens L2 are projected onto the holographic mirror H by a first mirror M1 (preferably a prism with total internal reflection) that makes an angle of 45° from the optical axis of the equaliser. Obviously, it would also be possible to use a mirror M1 with an angle other than 45°: in this case the holographic mirror H will be placed in a virtual focal plane, image of the image focal plane of L2 by the mirror M1, rather than on the optical axis.

The wavelengths of the spatial multiplex transmitted by the thick switchable hologram H (in other words the equalised wavelengths of the spatial multiplex) are reinjected into the equaliser through a second mirror (preferably a prism with total internal reflection) that also forms an angle of 45° from the optical axis of the equaliser. Once again, the mirror M2 can also have an angle not equal to 45°.

As in the equaliser in FIG. 1, the equalised spatial multiplex is retransformed into an equalised multiplex of wavelengths by the optical system composed of the dispersive optical element D and the first and second lenses L1 and L2.

However in this embodiment, the equalised wavelengths output from the first lens L1 focus on the output optical fibre Fₒᵤₜ placed symmetrically to the input optical fibre Fᵢₙ about the optical axis of the equaliser.

The wavelengths reflected by the hologram H after passing through the optical system (D, L1, L2) are, by construction, reinjected into the input optical fibre Fᵢₙ. This disadvantage can easily be corrected, for example by placing an isolator at the end of the input optical fibre Fᵢₙ, or by switching the reflected beam to a control optical fibre, not shown in FIG. 3, by means of a three-port circulator also placed at the end of the input optical fibre Fᵢₙ.

It would also be possible to use a holographic mirror H with inclined strata, and to offset this mirror H from the image focal plane of the second lens L2 imaged by the first mirror M1 (in other words to offset the holographic mirror H from the optical axis in the case in which the first mirror M1 forms an angle of 45° from the optical axis of the equaliser).

The variant embodiment shown in FIG. 4 is different from the equaliser presented in FIG. 1 in that the dispersive optical element D is displaced from the focal plane of the first and second lenses L1 and L2, to be moved towards the first lens L1. This configuration adds an angular multiplex in the imagery plane (around an angle that is not zero from the normal to the programmable semi-transparent holographic mirror H) to the spatial multiplex.

The arrows represented in dashed lines between the dispersive optical element D and the hologram H represent axial rays corresponding to two wavelengths of the multiplex considered λₘ and λₙ where λₘ<λₙ.

The advantages of this embodiment will be discussed in more detail in the remainder of this document.

In the embodiment shown in FIG. 5, the optical assembly comprising the first lens L1 and the dispersive optical element D is replaced by a single element, namely a holographic lens HL. Preferably, the holographic lens HL is chosen such that the axial ray of one of the wavelengths of the angular multiplex passes through the focus PF of the holographic lens. The result is that the angular multiplex is now around the perpendicular to the holo-PDLC type holographic mirror H.

FIG. 5 shows the axial rays associated with two wavelengths λ₁ and λ₂ of the multiplex considered. The axial ray associated with the wavelength λ₁ is shown in solid lines firstly between the holographic lens HL and the second lens L2, and secondly between the second lens L2 and the holographic mirror H. The axial ray associated with the wavelength λ₂ is shown in dashed lines firstly between the holographic lens HL and the second lens L2, and secondly between the second lens L2 and the holographic mirror H. λ₁ is the smallest wavelength of the DWDM comb input into the equaliser, and λ₂ is the next wavelength in the comb.

We will now describe the technical and functional characteristics of the dispersive optical element D and the controllable semi-transparent holographic mirror H used in the embodiments shown in FIGS. 1 to 5, in more detail. The general principles of the invention is based on the combination of these two elements, used in a predetermined usage configuration, to make a fast dynamic spectral equaliser with a wide spectral band.

The main characteristics of the dispersive optical element D are its spectral passband (including polarisation effects), its efficiency and its dispersive capacity. An ideal dispersive optical element D would have the following characteristics:
a high dispersive capacity, so as to be able to make a spatial separation between imaged spots corresponding to points of impact of the different wavelengths of the multiplex to be equalised on the holo-PDLC type holographic mirror H;
efficiency equal to approximately 100% on the band of wavelengths considered;
insensitivity to polarisation of the beam of multiplexed wavelengths.

Volume Phase Holographic (VPH) gratings have characteristics similar to the characteristics of the ideal dispersive optical element. VPH gratings are optically recorded by placing a photosensitive film a few tens of microns thick in the interference region of two coherent light beams. The interference figure is recorded in the volume of the film in the form of a generally sinusoidal modulation of the refraction index.

In order to satisfy the conditions mentioned above (high dispersive capacity, good efficiency, insensitivity to polarisation), it is essential to use a long life photosensitive material with a strong modulation of the refraction index, that absorbs and diffuses only slightly in the wavelength band considered. Dichromated Gelatine (DCG) and photopolymers are almost ideal materials for recording VPH type gratings, as described by R. R. A. Syms, in “Practical Volume Holography”, Clarendon Press, Oxford, 1990. Their diffraction efficiency may be more than 95%. Moreover, the lives of DCG based gratings are at least 20 years, provided that sealing conditions are adequate.

Like traditional thin gratings, VPH gratings diffract light according to the classical grating equation. But the distribution of diffracted energy is governed by the Bragg condition:

$$2 n sin ( {θ}_{B} ) = \frac{{λ}_{B}}{Λ}$$

where n is the average refraction index of the medium, θ_{B} is the angle of incidence and diffraction inside the grating, measured with respect to strata (also called the Bragg angle), λ_{B} is the Bragg wavelength (in a vacuum) and Λ is the period of the grating.

The energy diffracted by the grating is maximum when the wavelength and angle of incidence pair of the incident light satisfies the Bragg condition. A beam for which the characteristics vary slightly from Bragg conditions may be efficiently diffracted using the grating parameters.

Based on Kogelnik's coupled wave theory (H. Kogelnic, “Coupled Wave Theory for Thick Hologram Gratings”), The Bell System technical Journal, 1969), the diffraction efficiency of an ideal non-inclined VPH transmission grating can be estimated as follows, as a first approximation:

$${η}_{t} = \frac{{sin}^{2} ( Φ \sqrt{1 + {X}^{2} / {Φ}^{2} )}}{( 1 + {X}^{2} / {Φ}^{2} )}$$

$$where Φ = \frac{π Δ nd}{λ cos ( {θ}_{B} )}$$

$$X = \frac{π d}{cos ( {θ}_{B} )} [ Δ θ \frac{cos ( {θ}_{B} )}{Λ} - Δ λ \frac{1}{2 n {Λ}^{2}} ]$$

Δθ is the difference between the angle and the Bragg angle θ_{B}, Δλ is the difference between the wavelength (in a vacuum) and the Bragg wavelength λ_{B}.

According to the Bragg condition (Δλ=0 and Δθ=0), the diffraction efficiency becomes:

$${η}_{t} = {sin}^{2} Φ = {sin}^{2} ( \frac{π Δ nd}{{λ}_{B} cos {θ}_{B}} )$$

This equation shows that the maximum diffraction efficiency of a transmission VPH grating is achieved if the following relation is satisfied between the wavelength, the index modulation and the grating thickness:
2Δnd=λ_{B} cos(θ_{B})

As in traditional thin gratings, VPH gratings are also sensitive to the polarisation of incident light. The above equations are valid for a TE type of light polarisation. If incident light is polarised in the TM plane, the parameter Φ has to be corrected as follows:
Φ_{TM}=Φ_{TE} cos(2θ_{B})

As long as the angle between the incident and diffracted beams is not close to 90°, the diffraction efficiency hardly varies depending on the polarisation state.

For the purposes of this invention, non-inclined VPH gratings will preferably be used, since they have several technological advantages compared with VPH gratings with inclined strata, for example such as insensitivity to thickness changes.

Obviously, the invention is also applicable to any other type of dispersive optical element, and particularly to VPH type gratings with inclined strata. However, for simplification reasons we will restrict the remainder of this description to non-inclined VPH gratings. A person skilled in the art will find it easy to deduce the characteristics of a dynamic spectral equaliser according to the invention using any other type of dispersive optical element.

The illustrated architecture of the optical system would have to be modified to implement a non-inclined VPH grating in the dynamic spectral equaliser in FIG. 1.

A first possible adaptation of the set up in FIG. 1 consists of moving the input optical fibre Fᵢₙ of the optical axis, for example as shown in FIG. 3.

A second possible adaptation consists of maintaining the input optical fibre Fᵢₙ on the optical axis as shown in FIG. 1, and using a combination of two prisms and a non-inclined VPH grating as a dispersive optical element D. This type of combination shown in FIG. 6 is called a grism.

This type of grism comprises a first prism P1, a VPH type grating denoted VPHG in FIG. 6, and a second prism P2. The non-inclined grating VPHG includes strata F perpendicular to the faces of the grating. The dashed line L passing through the grism from one side to the other represents a light beam.

For simplification reasons, this description is restricted to modifications to be made to the diagram in FIG. 1 so that a non-inclined VPH type grating can be used as a dispersive optical element. Obviously, a person skilled in the art would find it easy to deduce modifications to be made to the diagrams in FIGS. 2 to 5 to be able to use such VPH gratings in the dynamic spectral equalizer according to the invention.

FIGS. 7 and 8 present the results of digital simulations showing the distribution of the diffraction efficiency for two VPH gratings with different spatial periods (3 and 4 microns respectively). In these two figures, the thickness of the photosensitive film is 50 microns for the two gratings, the average refraction index is 1.51 and the modulation of the refraction index Δn is equal to approximately 0.015 and is different for each of the two gratings.

FIGS. 9 and 10 show simulated spatial dispersion characteristics of these gratings when they are placed in the Fourier plane of a 4-f system, for example like that shown in FIG. 1. The results in FIG. 9 were obtained with a focal distance of 100 mm. The results in FIG. 10 were obtained with a focal distance of 75 mm.

The dispersion capacity (Δx/Δλ) resulting from the configuration in FIG. 9 is 27.5 microns/nm, in other words for a spacing of 0.4 nm between DWDM channels, the distance between two spots associated with two adjacent wavelengths on the holographic mirror H is equal to approximately 11 microns.

The dispersion power (Δx/Δλ) resulting from the configuration in FIG. 10 is 26 microns/nm, in other words for a spacing of 0.4 nm between DWDM channels, the distance between two spots associated with two adjacent wavelengths on the holographic mirror H is equal to approximately 10.4 microns.

We will now describe the technical and functional characteristics of the element according to the invention responsible for spectral equalization of the multiplexed wavelength beam, namely the thick switchable hologram.

This type of volume hologram generates a wave front predetermined using diffractive structures recorded in a holographic medium. One important characteristic of thick holograms is that the efficiency with which the wave front is generated depends strongly on the wavelength and the angle of incidence of light with respect to the hologram.

The efficiency is maximum for illumination at the Bragg wavelength, with an angle of incidence equal to the Bragg angle. A thick switchable hologram is a thick hologram for which the diffraction efficiency can be electrically controlled between 0% and 100%.

For the purposes of this invention, a thick switchable hologram is used so as to reproduce the effect of a mirror for which the reflectivity at the Bragg condition can be varied between approximately 0% and 100%.

This hologram is optically recorded in Polymer Dispersed Liquid Crystal (PDLC) during a single step process, in which a holo-PDLC is formed. As reported by R. Sutherland and al in patent document U.S. Pat. No. 5,942,157 (“Switchable Volume Hologram Materials and Devices”), the PDLC materials are used to record phase holograms in reflection with high diffraction efficiencies. Switching voltages may be as little as 50 Vrms for frequencies from 1-2 kHz, for example by adding a surfactant to the PDLC material.

A sample is prepared by applying a mix formed from a monomer, a liquid crystal, a binding monomer, a co-initiator, a photo-initiating colouring agent and a surfactant between two glass plates separated by spacers with an appropriate thickness, as detailed in the remainder of this document. The glass plates are covered by indium-tin oxide (ITO) strips forming pixelised electrodes.

The sample is then placed in the interference region between two coherent light beams and a photo polymerisation process is induced by the optical intensity distribution. In high illumination areas, the concentration of liquid crystal (LC) droplets will be small, while low illumination areas will be rich in liquid crystal droplets.

Thus, the interference figure is recorded in the form of a variation in the concentration of liquid crystal droplets in the PDLC material. Since the refraction index of the liquid crystal droplets is not the same as the refraction index of the polymer surrounding them, the hologram is stored in the form of a modulation of the refraction index in the holographic medium. The difference between the refraction index of liquid crystal droplets and of the polymer may be controlled by the voltage applied to the ITO electrodes. Since the diffraction efficiency of a volume phase hologram depends on the modulation of the refraction index, this efficiency may be controlled by the voltage applied to the electrodes.

The size of the liquid crystal droplets is an important factor determining the effect of the PDLC medium on the light that illuminates it.

If the size of the droplets is of the order of magnitude of the wavelength of the incident light, the droplets act like Rayleigh diffusers.

If the size of the droplets is much smaller than the wavelength of incident light (for example for a droplet size smaller than 100 nm for the near infra-red) the PDLC medium becomes optically isotropic (in other words there is no diffusion) in the direction collinear with the applied field, and its net refraction index is determined by the refraction index of the polymer and that of the liquid crystal droplets.

The size of the liquid crystal droplets depends on the rate of polymerisation of the PDLC system; as this speed increases, the liquid crystal droplets become smaller. In order to produce good quality phase holograms, the size of the droplets must be fairly small so that the holo-PDLC acts like a phase-shifting and non-diffusing medium. Sutherland and al (U.S. Pat. No. 5,942,157) reported recording of holograms in PDLC materials with liquid crystal droplets with a size within the 30-50 nm range, which is appropriate for the production of phase holograms with high diffraction efficiency.

The thick switchable hologram used in this invention must act like a programmable semi-transparent mirror. Therefore the diffraction structure is formed of strata parallel to the faces of the holographic medium. This type of hologram is called a reflection hologram. Reflection holograms under normal incidence have the important characteristic that they are insensitive to polarization.

For a phase hologram in reflection illuminated under normal incidence, the diffraction efficiency η is given by:

$$η = {[ 1 + \frac{1 - {( \frac{{λ}_{B} Δ λ}{2 {Λ}^{2} n Δ n} )}^{2}}{[ {sin}^{2} {eh ( \frac{π Δ nd}{{λ}_{B}} \sqrt{1 - {( \frac{{λ}_{B} Δ λ}{2 {Λ}^{2} n Δ n} )}^{2}} )}^{2} ]} ]}^{- 1}$$

where λ_{B} is the Bragg wavelength (in a vacuum) related to the period of the grating Λ by λ_{B}=2nΛ, n is the average refraction index of the holographic medium, Δn is the modulation of the refraction index, Δλ is the difference between the wavelength and the Bragg wavelength, and d is the thickness of the hologram.

This expression is valid for all polarization states of incident light.

Under the Bragg condition (Δλ=0), the diffraction efficiency becomes:

$$η = {[ tan h ( \frac{π Δ nd}{{λ}_{B}} ) ]}^{2}$$

This relation shows that the diffraction efficiency increases with the product Δnd. Δn depends on the amplitude of the electric field within the PDLC material, which increases with the voltage and decreases with the thickness of the hologram d. For a 20 micron thick hologram, the largest value of the index modulation that can be expected while keeping switching voltages low is less than 0.05, as described by A. K. Fontenecchio, Ch. C. Bowles and G. P. Crawford in “Improvement of holographically formed polymer dispersed liquid crystal performance through acrylated monomer functionality studies”, SPIE Conference on Liquid Crystals III, 1999.

FIG. 11 shows a graph of the diffraction efficiency as a function of the modulation of the refraction index Δn for a phase hologram with a thickness d=20 microns, illuminated at the Bragg wavelength λ_{B}=1.55 μm.

FIG. 12 shows a graph of the diffraction efficiency as a function of the wavelength for a phase hologram with a thickness d=20 microns, a refraction index modulation equal to 0.03 and period Λ=0.505 μm.

This graph shows that it is impossible to cover a wide range of wavelengths while maintaining a constant grating period. The inventors of this invention have envisaged introducing a spatial chirp into the holographic grating H to compensate for the variation of the wavelength along the dispersion axis (in other words to compensate for the chromatism due to diffractive optics of the equalizer).

For the purpose of the description in the remainder of this document, a spatial chirp means a spatial variation of the period of the holographic grating H, approximately following a gradient (or a ramp).

Thus, as the wavelength of the incident light increases, the period of the holographic grating behind the pixel illuminated by the wavelength considered will increase. Therefore a switchable hologram H for which the period varies continuously from Λ=0.49 microns to Λ=0.52 microns covers a range of wavelengths from λ=1.5 microns to λ=1.6 microns (assuming that the average refraction index of the PDLC material is 1.53). This is illustrated by the graph in FIG. 13 which gives the diffraction efficiency of a volume phase grating in reflection H with a thickness of 20 microns, with a refraction index modulation equal to Δn=0.03, with a chirp rate (ΔΛ/λx) equal to 1.2*10⁻5, assuming that the dispersive power (Δx/Δλ) of the optics (in other words of the dispersive optical element D and the lenses L1 and L2) is 25 microns/nm.

A chirped grating in reflection can be recorded by placing the PDLC sample in the interference region of two divergent beams. FIG. 14 shows a diagrammatic representation of a pixelised thick switchable chirped hologram made with such a recording set-up.

This type of hologram has six electrodes E, a common ground CG, two glass plates G and chirped strata P. The double arrows λ₁ to λ₆ shown in FIG. 14, incident on the six electrodes E, represent six wavelengths of the DWDM comb supplying the equalizer according to the invention, each of which has an impact point on a different pixel of the hologram H. We have λ₁<λ₂< . . . <λ₆. Therefore the hologram H will reflect each of these wavelengths differently depending on the voltage applied to the electrode E corresponding to the point of impact of the wavelength λᵢ.

As shown in this FIG. 14, the fringes of a chirped grating are slightly inclined from each other. However, the angle between two adjacent fringes is less than 10⁻³ degrees, therefore it can be considered approximately that the fringes are parallel to each other, as discussed by S. M. Schultz, E. N. Glytsis and T. K. Gaylord in “Design of a high-efficiency volume grating coupler for line focusing”, Applied Optics, 1998.

This fringe inclination gradient may be minimized by adding an angular multiplex to the spatial multiplex, in other words by compensating for the spatial variation of the wavelength along the dispersion direction by a spatial variation of the angle of incidence of the wavelengths. This compensation may be achieved by moving the multiplexing dispersive optical element D from the focal plane of the 4f set-up, as shown in the set-ups in FIGS. 4 and 5.

In order to guarantee optical isotropy of the holo-PDLC H in reflection in this case, the set of electrodes and counter-electrodes needs to be made more complicated such that the field inside the holo-PDLC is co-linear with the direction of propagation of the wavelengths.

1. Dynamic spectral equaliser,
comprising:
means of demultiplexing an incident beam with at least two multiplexed wavelengths, comprising at least one first dispersive optical element, so as to form a spatial multiplex of the said at least two wavelengths;
means of attenuating the spectral power associated with at least one wavelength of the said spatial multiplex, comprising at least one programmable semi-transparent holographic mirror, so as to form an equalised spatial multiplex;
means of multiplexing the said equalised spatial multiplex, comprising at least one second dispersive optical element, so as to form an equalised beam with at least two multiplexed wavelengths,
and in that the said holographic mirror (H) is optically recorded in polymer dispersed liquid crystal (PDLC) so as to form a holo-PDLC.

2. Dynamic spectral equaliser according to claim 1, wherein the said first and second dispersive optical elements are coincident.

3. Equaliser according to claim 1, wherein the said holographic mirror (H) is a volume holographic grating in reflection.

4. Equaliser according to claim 1, wherein the said holographic mirror (H) is chirped.

5. Equaliser according to claim 1, wherein the said holographic mirror (H) comprising at least two strata, the direction of propagation of the said incident spatial multiplex on the said holographic mirror is approximately perpendicular to the said strata.

6. Equaliser according to claim 1, wherein the said dispersive optical element (D) is a volume phase holographic grating.

7. Equaliser according to claim 1, wherein it also comprises:
at least one input port (1) of the said incident beam with at least two multiplexed wavelengths into the said equaliser;
at least one first output port of the said equalised beam with at least two multiplexed wavelengths from the said equaliser.

8. Equaliser according to claim 7, wherein the said input port and the said first output port are coincident.

9. Equaliser according to claim 1, wherein the said at least one holographic mirror comprises at least two electrodes for electrically controlling the reflectivity of at least some areas of the said mirror.

10. Equaliser according to claim 1, wherein it also comprises:
an input optical fibre (Fᵢₙ) transporting the said incident beam with at least two multiplexed wavelengths to the said input port;
a first lens (L1) positioned such that the said input port is in the object focal plane of the said first lens;
a second lens (L2) positioned such that the said holographic mirror is in the image focal plane of the said second lens, and that the object focal plane of the said second lens is coincident with the image focal plane of the said first lens;
an output optical fibre (Fₒᵤₜ) that receives the said equalised beam with at least two multiplexed wavelengths, from the said first output port.

11. Equaliser according to claim 10, wherein the said dispersive optical element (D) is located in the image focal plane of the said first lens (L1) and in the object focal plane of the said second lens (L2).

12. Equaliser according to claim 10, wherein the said dispersive optical element is a grism, comprising two prisms and a non-inclined volume phase holographic grating, and in that the said input optical fibre is located on the optical axis of the said equaliser.

13. Equaliser according to claim 10, wherein it also comprises a three-port circulator, capable of transmitting the said incident beam with at least two multiplexed wavelengths from the said input optical fibre (Fᵢₙ) to the said input port and transmitting the said equalised beam with at least two multiplexed wavelengths from the said output port to the said output optical fibre (Fₒᵤₜ).

14. Equaliser according to claim 10, wherein the said dispersive optical element is used in a configuration in reflection, and in that the said first and second lenses are coincident.

15. Equaliser according to claim 10, wherein the said dispersive optical element is located between the said first and second lenses, near the said first lens.

16. Equaliser according to claim 10, wherein the said dispersive optical element and the said first lens are replaced by a single holographic lens (HL), chosen such that the axial radius of a wavelength of the said beam with at least two multiplexed wavelengths emerges from the said holographic lens and passes through a focus of the said holographic lens.

17. Equaliser according to claim 1, wherein it also comprises a second output port, capable of receiving at least one wavelength of the said spatial multiplex transmitted by the said holographic mirror.

18. Equaliser according to claim 10, wherein the said dispersive optical element is a non-inclined volume phase holographic grating and in that the said input optical fibre is located at a distance from the optical axis of the said equaliser.

19. Equaliser according to claim 10, wherein the said spatial multiplex is projected onto the said holographic mirror by a first mirror (M1),
and in that the said equalised spatial multiplex transmitted by the said holographic mirror is aimed towards the said second lens by a second mirror (M2).

20. Equaliser according to claim 19, wherein at least one of the first and second mirrors is a prism with total internal reflection.

21. Equaliser according to claim 19, wherein the said input and output optical fibres are symmetrically located about the optical axis of the said equaliser.

22. Equaliser according to claim 19, wherein it also comprises an isolator to isolate the said input optical fibre from the said spatial multiplex reflected by the said holographic mirror.

23. Equaliser according to claim 19, wherein the said holographic mirror is placed in a virtual focal plane that is an image of the image focal plane of the said second lens by the said first mirror (M1).

24. Equaliser according to claim 19, wherein the said first and second mirrors form an angle of approximately 45° from the said optical axis,
and in that the said holographic mirror is placed along the said optical axis.

25. Equaliser according to claim 19, wherein the said holographic mirror is a holographic mirror with inclined strata, and in that it is placed at a distance from a virtual focal plane, that is an image of the image focal plane of the said second lens by the said first mirror, such that the said spatial multiplex reflected by the said holographic mirror is not reinjected into the said input optical fibre.

26. Equaliser according to claim 18, wherein it also comprises a second output port, capable of receiving at least one wavelength of the said spatial multiplex reflected by the said holographic mirror.
